(19) United States
(12) Patent Application Publication
(10) Pub. No.: US 2015/0332637 A1
(43) Pub. Date: Nov. 19, 2015

(54) DRIVING A DISPLAY

(71) Applicant: HEWLETT-PACKARD DEVELOPMENT COMPANY, L.P., Houston, TX (US)

(72) Inventors: GREGG COMBS, MONMOUTH, OR (US); DEVIN ALEXANDER MOUREY, ALBANY, OR (US); RANDY HOFFMAN, CORVALLIS, OR (US)

(21) Appl. No.: 14/652,364

(22) PCT Filed: Dec. 14, 2012
(86) PCT No.: PCT/US12/69824

§ 371 Date: Jun. 15, 2015

(51) Int. Cl. G09G 3/34; G02F 1/167

(52) U.S. Cl. CPC G09G 3/3446; G02F 1/167; G09G 3/3413; G09G 2330/028

(57) ABSTRACT

A method of driving a display, the method comprising applying a switching voltage to the display, the switching voltage causing an amount of electrically charged pigment particles to be compacted into a number of wells defined in a dielectric layer in the display, applying a transition waveform to the display, and applying a holding voltage to the display.

### BACKGROUND

Electrokinetic based devices are devices that employ electrokinetic and electrophoretic principles to move charged pigments in a carrier fluid within a display element. In the presence of an electric field, the colored particles are pushed into a minimal area within the display element often called a well. The cross-sectional area of this well may be relatively insignificant as compared to the cross-sectional area of the display element. As a result, the electrokinetic display element may switch between a colored state and a clear or transparent state.

The display element may be a single display element among many display elements. In this fashion, many display elements may each act as pixels within a single color display. This architecture allows different color displays comprising a number of display elements to be stacked on each other. In one example, each display may comprise a single type of colorant particle such that it adds a particular color to a color model such as CMYK and RGB color models.

During operation, the pigments are dispersed within the display element when no voltage is applied. This results in a maximum color state. When a maximum voltage is applied, the pigments are drawn into the well resulting in a maximum amount of clarity. However, in an attempt to obtain an intermediate level of pigment saturation in the display element and thus achieve a certain grey level, a certain voltage between 0 and the maximum may be applied. Even this, however, may not result in appropriate grey levels because the intermediate voltage may still serve to cause complete compaction, albeit over a relatively longer period of time, or the intermediate voltage may not be enough to suitably compact the pigment into the well.

### BRIEF DESCRIPTION OF THE DRAWINGS

The accompanying drawings illustrate various examples of the principles described herein and are a part of the specification. The examples do not limit the scope of the claims.

FIGS. 1A and 1B are block diagrams of one example of an electrokinetic display element according to one example of principles described herein.

FIGS. 2A-2B is a diagram of a driving matrix of a display according to one example of principles described herein.

FIG. 3 is a side-by-side comparison of the scan cycles and the voltage waveforms used to create dark, clear, and grey levels in a display element according to one example of the principles described herein.

FIGS. 4A-4C are graphs showing a comparison of the switching voltages using a step function and the transition function and a graph showing the display response produced by these two functions applied to the display over time according to one example of the principles described herein.

FIG. 5 is a graph showing example switching and holding voltages as a function of display response (relative lightness) of the display and data voltage used according to one example of the principles described herein.

FIG. 6 is a flowchart describing a method of driving a display according to one example of the principles described herein.

Throughout the drawings, identical reference numbers designate similar, but not necessarily identical, elements.

### DETAILED DESCRIPTION

As mentioned above, the pigments within an electrokinetic display element are fully compacted or fully dispersed within the display element when a maximum amount of voltage is or is not applied respectively. However, obtaining intermediate gray levels in each display element cannot be suitably achieved by simply applying an intermediate amount of voltage to the display element. Indeed, applying an intermediate voltage, in one instance, may result in the pigments in the display element slowly being compacted into the well, producing a fully clear or transparent state. This results in the image in the display disappearing as the pigments are fully compacted into the well. Also, applying an intermediate voltage, in another instance, may result in the pigments not being compacted in the well at all. In either case, the image state is not stable as a function of time.

Instead of simply applying an intermediate voltage, the application of a voltage is to take into account the forces involved within the display elements that are to be overcome. For example, although applying a voltage to the display element may drive the pigments into the well, the pigments themselves are each electrically charged such that they are inherently repulsive to each other. Additionally, because of the fluidic forces involved, once the voltage is applied, the pigments tend to naturally continue towards the well. These forces, among others, are to be balanced sufficiently in the display element so as to repeatably achieve finer grey levels. In one example, of the present application, this is done by applying a relatively high switching voltage for a relatively short period of time and then applying a relatively lower holding voltage in order to maintain or hold a certain grey level. Due to the inertia of the pigments, the abrupt voltage step from the switchin voltage to the holding voltage may result in an overshoot of the display response as the optical state of the display moves briefly beyond the desired steady-state value causing a flash on the display device that may be displeasing to a viewer of the display. In order to eliminate this flash, a waveform may be applied during the transition between the switching voltage and the holding voltage which accounts for the inertia of the pigments and prevents the overshoot from occurring. In this case, a viewer of the display will not see an optical flash of the screen.

The present specification therefore describes a method of driving a display, the method comprising applying a switching voltage to the display, the switching voltage causing an amount of electrically charged pigment particles to be compacted into a number of wells defined in a dielectric layer in the display, applying a transition waveform to the display, and applying a holding voltage to the display. The present specification further describes a display element, comprising a first electrode, a second electrode opposed to the first electrode, a number of wells defined in a dielectric layer disposed in between the first and second electrodes, and a fluid comprising an amount of electrically charged pigment particles dispersed in between the first and second electrodes, in which application of an intermediate voltage between a minimum and maximum voltage is applied to the display element to force a portion of the electrically charged pigment particles into the number of wells to achieve a grey level in the display element, and in which the grey level is maintained by applying a transition waveform and a subsequent holding voltage to the display element.

The present specification further comprises a computer program product for driving a display, the computer program product comprising a computer readable storage medium comprising computer usable program code embodied therewith, the computer usable program code comprising computer usable program code to, when executed by a processor, apply a switching voltage to the display, the switching voltage causing an amount of electrically charged pigment particles to be compacted into a number of wells defined in a dielectric layer in the display. The computer usable program code may further comprise computer usable program code to, when executed by a processor, apply a transition waveform to the display and computer usable program code to, when executed by a processor, apply a holding voltage to the display.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

In the present specification and in the appended claims, the term “electrokinetic based device” or “electrokinetic device” is meant to be understood broadly as any device which uses the electrokinetic phenomena to help produce an image on a display by moving dispersed particle in a fluid using an electric field. A number of examples include reflective displays which use a reflective surface or white reflective surface to reflect back ambient light or white light. However, although the present specification may describe examples which use a reflective-type display, the present specification is meant to be applicable to any electrokinetic based device whether reflective or transmissive.

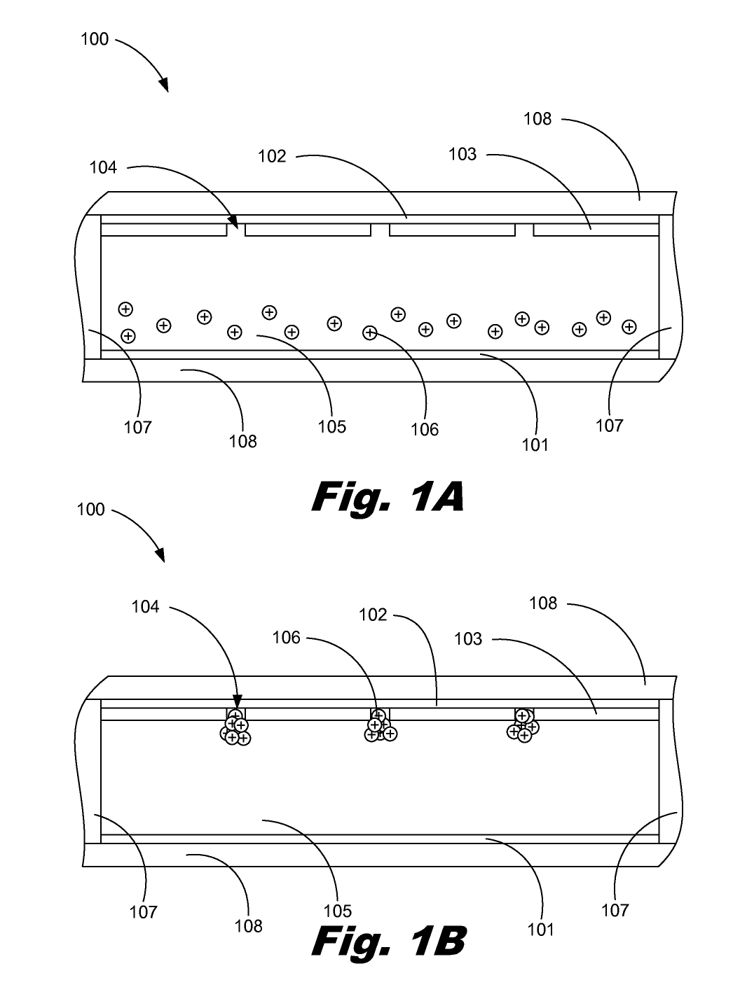

Turning now to FIGS. 1A and 1B, block diagrams of one example of an electrokinetic display element (100) are shown according to one example of principles described herein. In FIG. 1A, the display element (100) is in a dark (colored) state while with FIG. 1B the display element (100) is in a clear state. Electrokinetic display elements are described in U.S. Pat. No. 8,018,642, entitled “Electro-Optical Display” to Jong-Souk Yeo et al., and is hereby incorporated by reference in its entirety.

The display element (100) includes a source electrode (101), a sink electrode (102), and a dielectric layer (103) with a number of wells (104) defined therein in which the sink electrode (102) and dielectric layer (103) are set apart from the source electrode (101) and define a space there between. The display element may further comprise a fluid (105) with a number of charged pigment particles (106) distributed throughout the fluid (105). The fluid (105) and pigment particles (106) may be contained in the space between the sink electrode (102)/dielectric layer (103) and source electrode (101) by a number of walls (107) and substrate surfaces (108).

In one example, the sink electrode (102), dielectric layer (103), and source electrode (101) are all comprised of transparent materials such that light may pass through them. In other examples, the sink electrode (102), dielectric layer (103), and source electrode (101), or combinations thereof are comprised of an opaque material.

In another example, the sink electrode (102), dielectric layer (103), and source electrode (101), or combinations thereof may be incorporated into a reflective display. Reflective displays use ambient light by reflecting ambient light from a reflective surface behind the display back to the user. As such, a reflective or white surface is placed behind any display elements (100) such that the ambient light will be reflected back to the user through the number of display elements (100). Therefore, in one example, a number of the display elements (100) may comprise a reflective surface such that the ambient light may be reflected back to the viewer through the display elements (100).

As described above, because any number of display elements (100) may be situated into a single color display, colored displays may be stacked or layered over other colored displays to create an additive or subtractive color model. In this case, the layer furthest from the viewer may comprise a sink electrode (102), dielectric layer (103), source electrode (101), or combination of these which comprises a reflective surface thereon. In another example, the layer furthest from the viewer may comprise a sink electrode (102), dielectric layer (103), source electrode (101), or combination of these which comprises a white reflector thereon such that white light is reflected back towards the viewer. After the light has passed through the subtractive or additive color displays, the image can be seen.

The fluid (105) may comprise polar water fluids (e.g., water) and non-polar fluids (e.g., dodecane). Additionally, other fluids such as anisotropic fluids (e.g., liquid crystal) may be used. The fluid (105) may further comprise surfactants, charging agents, stabilizers, dispersants, or combinations thereof. In one example, the surfactants may provide a fluid (105) that is an electrolyte that is able to sustain current by ionic mass transport.

In one example, the pigment particles (106) may be comprised of a single color that, as described above, complement other colors in other display elements (100) so as to form an additive or subtractive color model. The pigment particles (106) may be comprised of a charged material that is capable of maintaining a stable charge for an indefinite period of time so that repeated operation of the display element (100) does not affect the charge of the pigment particles (106).

In operation, the pigments (106) are allowed to disperse within the fluid and are generally repelled from each other as they are similarly charged thus creating a relatively uniform dark or colored state. In FIGS. 1A and 1B the pigments (106) are shown to have a positive charge associated with them. However, the pigments (106) having a positive charge associated with them is merely an example and the present specification and instead to present specification contemplates that the pigments (106) may have negative charges associated with them. In order to clear the pigments (106) from the display element (100) and drive them into the wells (104), an electric potential difference V is applied between the source electrode (101) and sink electrode (102). These effects are shown in FIG. 1B.

The voltages involved in switching from a dark state to a clear state may include switching from a positive voltage to a negative voltage or from a neutral voltage to a positive voltage, for example. In either case, however, achieving grey levels in the individual display elements cannot be accomplished effectively by applying a single specific intermediate voltage. Instead, a first intermediate switching voltage is applied for a relatively short period of time and then a second relatively lower hold voltage is applied to maintain a predetermined grey level in the display element (100). When this occurs, however, there may be some “overshoot” in the display response depending on the voltage levels applied. This may cause a relatively larger amount of pigment (106) to compact into the wells (104). Thus, when the relatively lower level of voltage is applied so as to hold the pigments (106) at a specific grey level, the inertia of the pigments (106) may not be sufficiently overcome and a relatively large amount of pigment (106) may rush into the wells (104) causing the display element (100) to flash. As this may continue to occur throughout a number of frames, this may create poor image quality and user dissatisfaction.

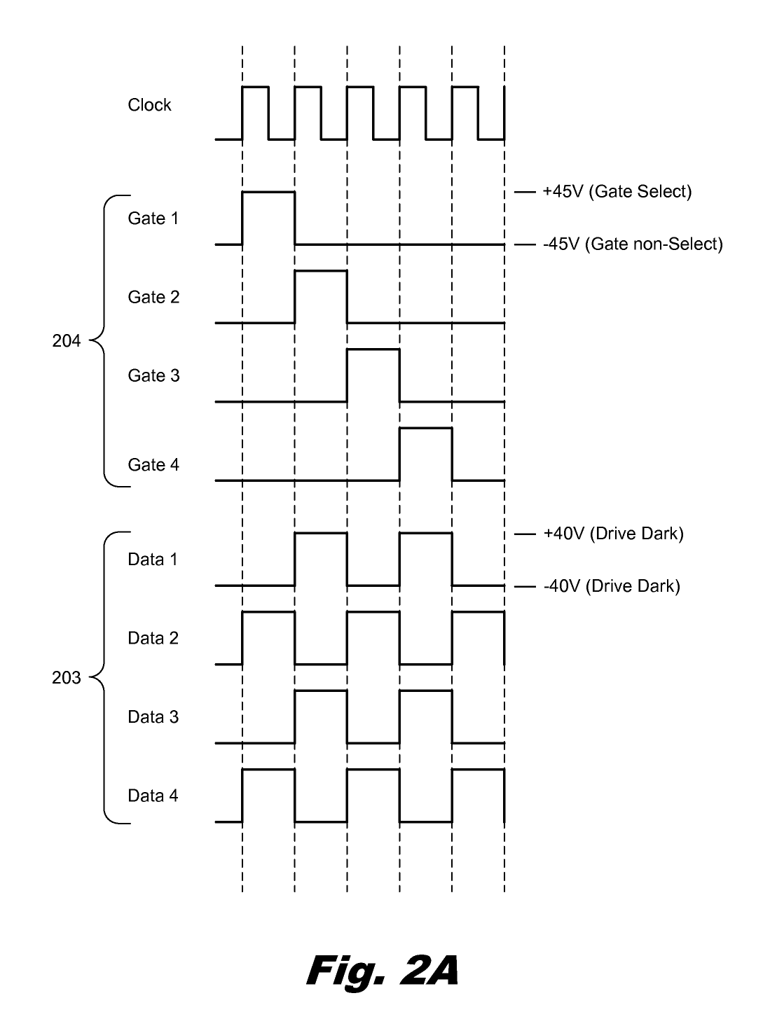

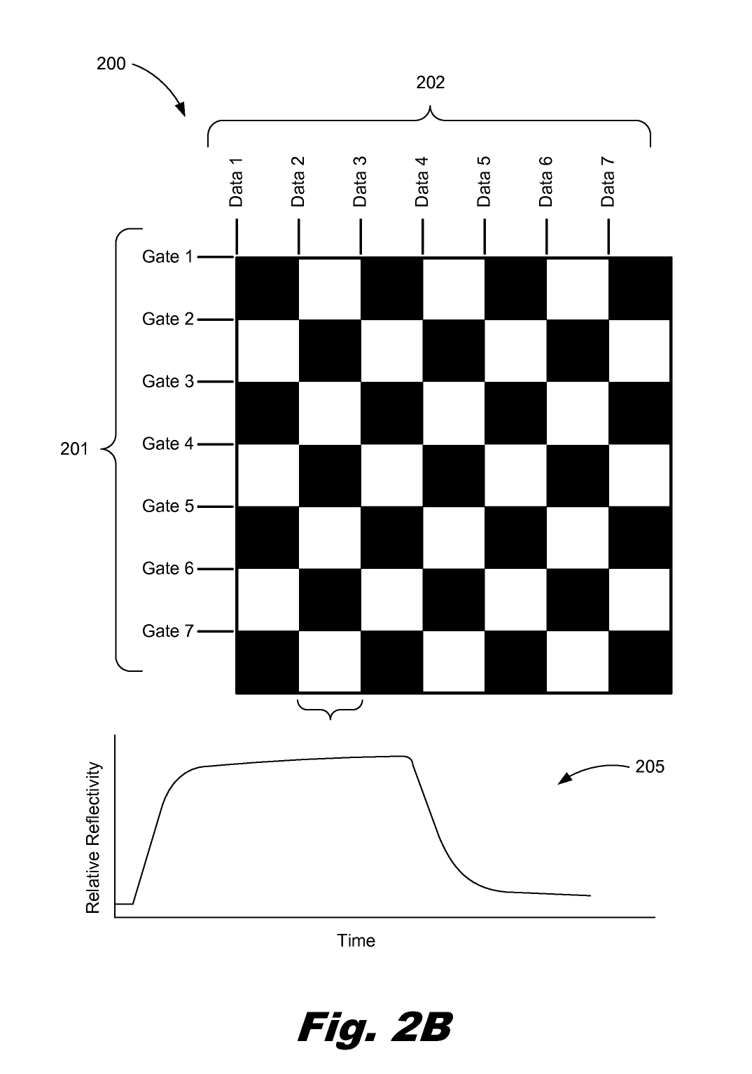

Turning now to FIGS. 2A and 2B, a diagram of a driving matrix (200) of a display is shown according to one example of principles described herein. In this example the display is configured with a thin-film transistor (TFT) active matrix backplane. As can be seen, a number of gate drivers (201) and a number of data drivers (202). Each of the data sets (203) associated with the data drivers (202) is clocked in at each gate line (204) to create an image on the display. FIG. 2B also includes a waveform (205) describing the intensity of a single display element (FIG. 1A, 100) over a number of scan cycles. Although FIG. 2A shows specific maximum and minimum voltages of +/−45V respectively, this is an example and the present specification contemplates the use of different maximum and minimum voltages.

The waveform (205) in FIG. 2B shows that it may take a number of scan cycles to clear a single pixel or display element (FIG. 1A, 100) of a display. Because the switching time of any given display element (FIG. 1A, 100) going from a clear state to a dark state may be on the order of 100-200 ms or more, the result is that it may take up to 200 ms or more multiplied by the number of gate lines to switch the entire display, if each gate line is fully switched in a single gate cycle. To alleviate this, the scan rate may be increased so that a switching voltage waveform is applied across a number of display elements (FIG. 1A, 100) all at a single time. Multiple scan cycles may be used to switch a display element to a desired gray level.

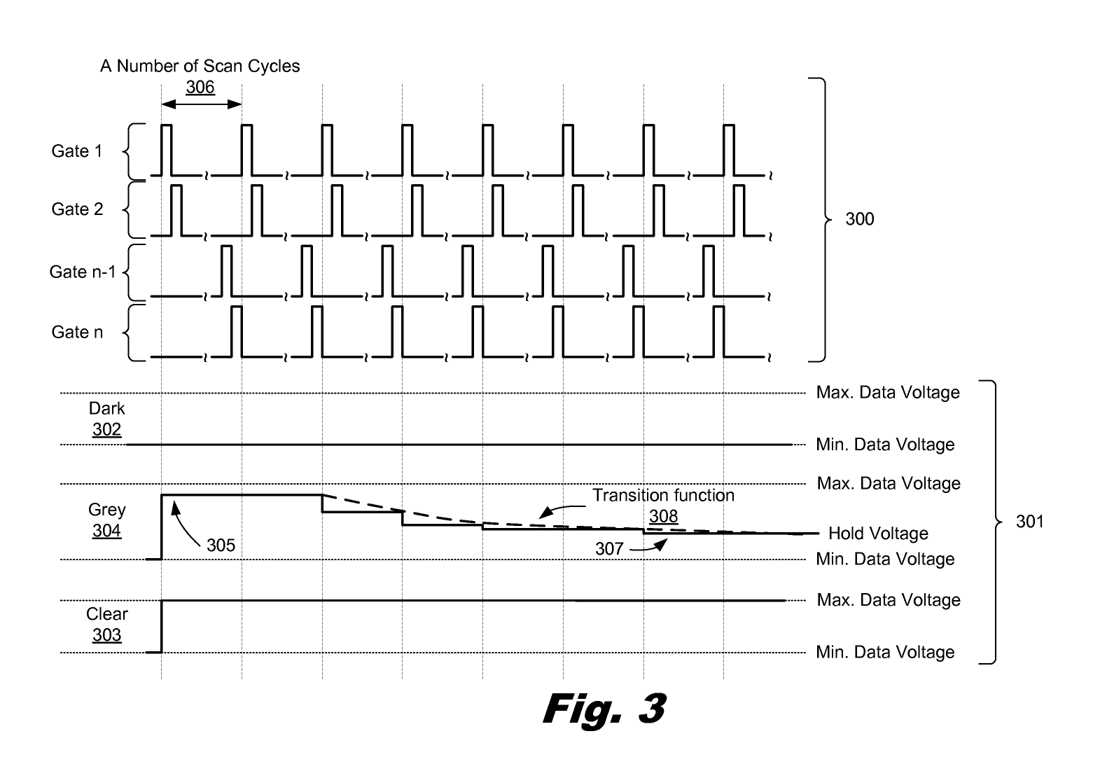

Using the multiple scan cycles, the flash effect described above may be prevented from occurring in each display element (FIG. 1A, 100). FIG. 3 shows a side-by-side comparison of the scan cycles (300) and the voltage waveforms (301) used to create dark (302), clear (303), and grey (304) levels in a display element (FIG. 1A, 100) according to one example of the principles described herein. As can be seen, to achieve a dark (302) state (corresponding to data 1 in FIG. 2B), a minimum voltage is applied. In one example, the minimum voltage may be 0. In another example, the minimum voltage may be a negative voltage such that the pigment (FIG. 1, 106) used will be forcefully spread out in the display element (FIG. 1A, 100). The voltage applied may also vary depending on the type of pigment (FIG. 1, 106) used in the display elements (FIG. 1A, 100) as well as other factors that may affect the performance of the display element (FIG. 1A, 106). Some of these other factors may include the type of fluid (FIG. 1A, 105) used, the viscosity of the fluid (FIG. 1A, 105) used, the volumetric size of the display element (FIG. 1A, 100), the architecture of the display element (FIG. 1A, 100), the age of the solution, and the temperatures at which the display elements (FIG. 1A, 100) are operated at, among others.

FIG. 3 also shows that to achieve a clear state in the display element (FIG. 1, 100), a maximum voltage is applied. This maximum voltage applied may again depend on those factors described above. Again, as the charge of the pigments (FIG. 1A, 106) used within the fluid (FIG. 1A, 105) varies, the voltage may be a negative voltage, a neutral voltage, or positive voltage. However, in one example, because the pigments (FIG. 1, 106) are positively charged, the maximum voltage causes the pigment (FIG. 1, 106) to be compacted into the wells (FIG. 1, 104). In one example, in order to improve the lifetime and power consumption of the display element, a transition down to a relatively lower hold voltage may be completed. This transition waveform may be similar to the transition waveform used to achieve grey levels as described below.

In one example, the maximum and minimum voltages described above may be +/−40V respectively. In another example, the maximum and minimum voltages may be +/−120V respectively. The specification, however, further contemplates the use of alternative maximum and minimum voltages.

To achieve a grey level in the display element (FIG. 1A, 100), a switching voltage (305) is first applied. In one example, for a first number of scan cycles (306) the switching voltage (305) is an intermediate voltage or some voltage between the maximum and minimum voltages. This intermediate voltage is applied so as to achieve the specific grey level. After that grey level has been reached, a holding voltage (307) may be applied to the display element (FIG. 1A, 100) so as to hold that grey level. In the example shown in FIG. 3, this may be done in a gradual manner such that for a number of successive scan cycles the voltage is gradually reduced till the grey level is maintained for an indefinite period of time. The method in which the holding voltage is lowered may be defined by a transition function (308). Therefore, the number of voltage changes within a number of cycles is defined by this transition function (308). In one example, the transition function (308) takes the general form of an inverse exponential function:

$$\frac{1}{{e}^{X}} \qquad ( Eq . 1 )$$

In this example, various coefficients may be used to compensate for the type of pigments (FIG. 1, 106), fluid (FIG. 1, 105) and architecture incorporated into the display element (100). Therefore, in one example, the transition function (308) is the inverse exponential function with the form:

$$\frac{a}{{e}^{bx}} \qquad ( Eq . 2 )$$

These coefficients (a, b) allow the display element (FIG. 1, 100) to be properly calibrated when the display element (FIG. 1, 100) is incorporating a specific type of pigment (FIG. 1, 106), fluid (FIG. 1, 105) and architecture. In this example, “a” is the voltage difference between the switching voltage and the holding voltage. This voltage may range anywhere from a minimum voltage to a maximum voltage (including 0 volts). More specifically, the voltage difference between the switching voltage and the holding voltage is a voltage that will depend on the electrical charge of the pigment (FIG. 1, 106). Additionally, “b” may depend on the step value for “x” where “x” is the sample rate or clock frequency. This sample rate may be in terms of seconds. Therefore, in one example, if “x is 1 ms then “b” would be between 0.1 and 0.0001, which in turn yields transition times of about 0.1 sec to 50 sec. As a result, the larger “b” is, the closer the step function is approached.

Other example functions may be used as the transition function (308). These may include a cosine function, a linear ramp, an arbitrary waveform, or a custom made curve, including modifications of each of these types of functions.

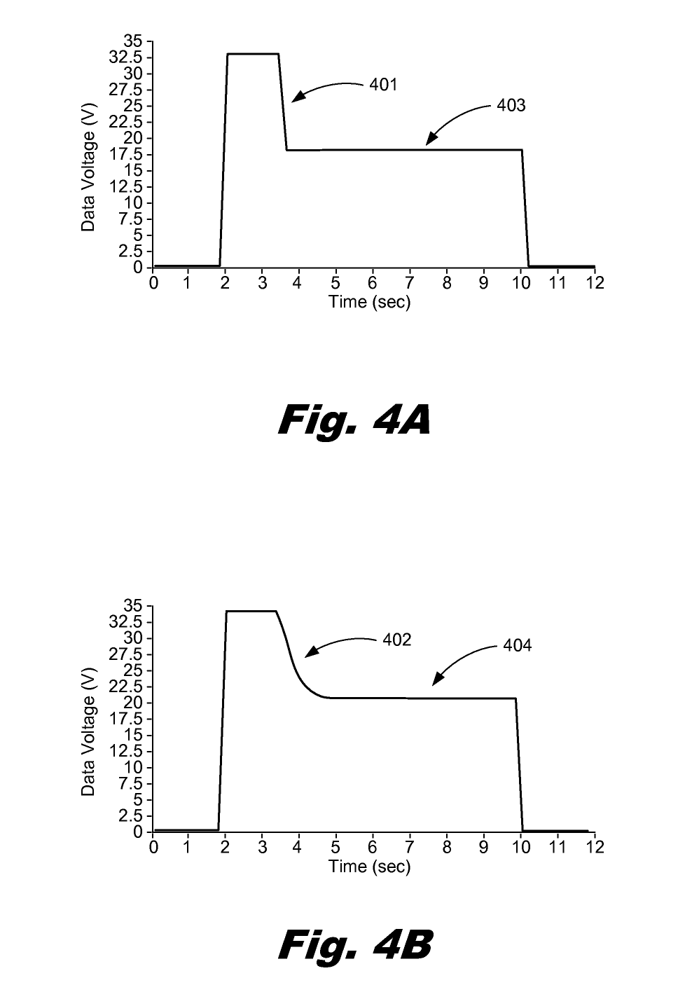

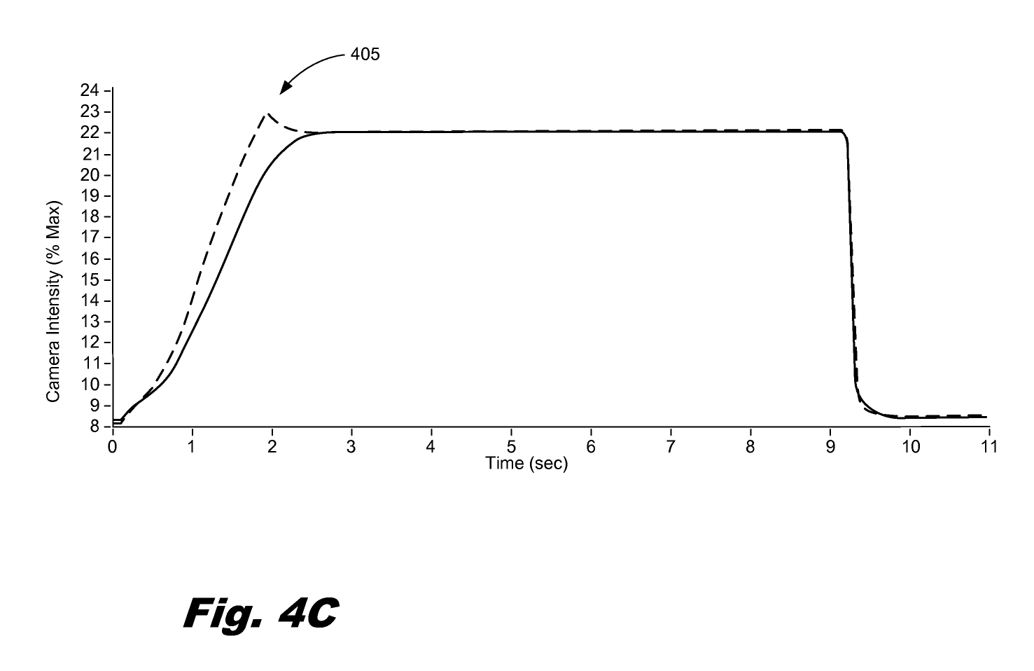

FIGS. 4A-4C are graphs which show a comparison of the switching voltages using a step function (401) and the transition function (402) according to one example of the principles described herein. FIGS. 4A and 4B show the data voltage comparison between the step function (401) and the transition function (402) described above as their respective holding voltages (403, 404) are applied. FIG. 4C shows that the display response to these two functions applied to the display elements (FIG. 1, 100) over time. Again, the voltages and time frames are meant to be examples and the present specification contemplates varying voltages and times applied to the display element (FIG. 1, 100) so as to accommodate any variables present in the display elements (FIG. 1, 100) such as the type of pigment (FIG. 1, 106) used and the architecture of the display elements (FIG. 1, 100) themselves.

The response of the display element (FIG. 1, 100) over time using the step function to first select a grey level and then step down to hold that level is shown in a dashed line in FIG. 4C. As can be seen, using the step function (401) results in a spike or overshoot (405). As described above, this overshoot (405) results in a flash on the screen viewable to the user. In contrast, the transition function (402) provides a smoother transition from a dark state to a grey level state without a peak or overshoot (405). The transition function (402) here allows for the energy to be distributed over a longer period of time to manage the inertia of the pigment (FIG. 1, 106) when the voltage causes the pigment (FIG. 1, 106) to be partially compacted into the well. As can be seen in FIG. 4C., the intensity of the display over time using the transition function (402) results in a relatively constant increase in color intensity shown by the solid line. An advantage of using the transition function (308, 402) is that the overshoot (405) is avoided while a reasonable switching speed is maintained.

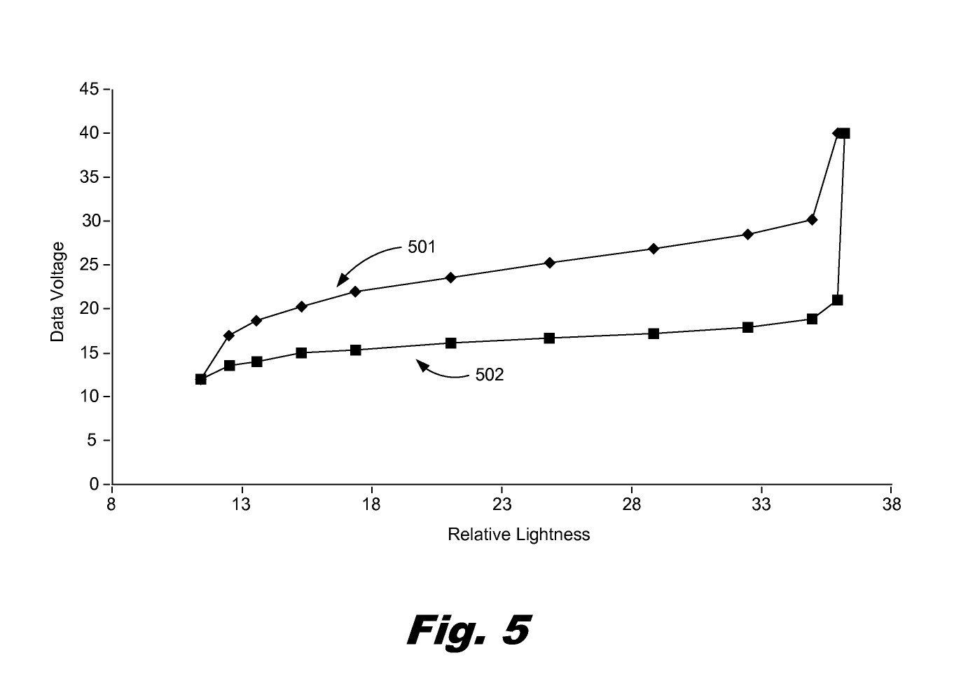

The transition function (308, 402) serves to achieve multiple grey levels in the display elements (FIG. 1, 100) and as a result in the display as a whole. These grey levels may allow individual colors in each display layer to be achieved causing a dramatic increase in the number of colors that can be achieved in the display. FIG. 5 is a graph showing example switching (501) and holding (502) voltages as a function of display response (relative lightness) of the display and data voltage used. The points in the graph of FIG. 5 is meant to merely representative and may vary depending, again, in the type of pigments (FIG. 1, 106), fluid (FIG. 1, 105) and architecture used. The vertical alignment of the switching voltage (501) points and the holding voltage (502) points represents a grey level that can be achieved on the display. These data points may be stored as a lookup table in a display driver or calculated from a mathematical function derived from a calibration process. Similar lookup tables may also be calibrated for the different pigments (FIG. 1, 106), fluid (FIG. 1, 105) and architecture used. The data stored on the lookup tables may be processed by a processor associated with the display element (FIG. 1, 100) in which the processor may cause those specific voltages to be applied to the display element (FIG. 1, 100).

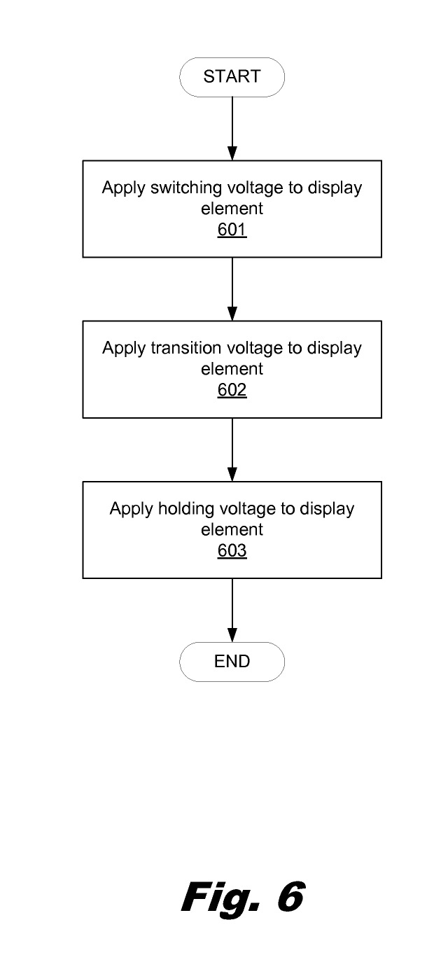

Turing now to FIG. 6, a method (600) of driving a display is show according to one example of the principles described herein. The method (600) may begin with applying (601) a switching voltage (FIG. 3, 305) to a display element (FIG. 1, 100). As described above, the switching voltage (FIG. 3, 305) may be an intermediate voltage that is in between a maximum and minimum voltage. The switching voltage (FIG. 3, 305) may be applied (601) to the display element (FIG. 1, 100) for some period of time so as to rapidly switch the device to an optical state or grey level that is close to the grey level of interest. Next, a transition waveform may be applied (602). The voltages of the transition waveform may be voltages that are between a switching voltage (FIG. 3, 305) and the holding voltage (FIG. 3, 307). After the transition waveform has been applied (602) such that the voltage reaches the holding voltage (FIG. 3, 307), the holding voltage (FIG. 3, 307) may then be applied (603) so as to maintain the grey level of interest.

The present specification further described a computer program product for driving a display. In one example, the computer program product comprises a computer readable storage medium comprising computer usable program code embodied therewith, in which the computer usable program code comprises computer usable program code to direct a switching voltage (FIG. 3, 305) to be applied to a display element. The computer usable program code may further comprise computer usable program code to direct a transition waveform and, subsequently, a holding voltage (FIG. 3, 307) to be applied to the display element such that a grey level is maintained on the display element.

The specification and figures describe a method of driving a display and a display element which implements a switching voltage, a holding voltage, and a transition waveform to create and maintain a number of grey levels. This method of driving a display may have a number of advantages. The method and display provides for analog control of the display such that, once the display is calibrated, any number of grey levels between a dark and clear state may be achieved. This feature, when coupled with the ability to have multiple layers of colored displays stacked on each other, allows for a relatively larger number of colors to be created on the display. Additionally, because of the relatively high voltage used to switch the display to a grey level, the display as a whole may be switched relatively faster. Still further, the transition waveform used provides for a smooth transition to desired grey levels without any flash on the screen. Even further, because of the application of a switching voltage, transition waveform, and holding voltage, the display can be driven from one grey level to another without having to reset the display electrically.

The preceding description has been presented to illustrate and describe examples of the principles described. This description is not intended to be exhaustive or to limit these principles to any precise form disclosed. Many modifications and variations are possible in light of the above teaching.

What is claimed is:

1. A display element, comprising:
a first electrode;
a second electrode opposed to the first electrode;
a number of wells defined in a dielectric layer disposed in between the first and second electrodes; and
a fluid comprising an amount of electrically charged pigment particles dispersed in between the first and second electrodes;
in which application of an intermediate voltage between a minimum and maximum voltage is applied to the display element to force a portion of the electrically charged pigment particles into the number of wells to achieve a grey level in the display element; and
in which the grey level is maintained by applying a transition waveform and a subsequent holding voltage to the display element.

2. The display element of claim 1, in which the transition waveform is applied according to an inverse exponential function.

3. The display element of claim 2, in which the inverse exponential function is:
$$\frac{a}{{e}^{bx}}$$
in which “a” is the voltage difference between the switching voltage and the holding voltage, “x” is dependent on the sample rate of the display element, and “b” is a step value of the sample rate.

4. The display element of claim 3, in which “a” and “b” are dependent on the type of electrically charged pigment particles, display architecture, fluid used in the display element, or combinations thereof.

5. The display element of claim 1, in which the transition waveform is applied according to a cosine function, a linear ramp, an arbitrary waveform, a custom made curve, or combinations thereof.

6. The display element of claim 1, in which the display element is an electrokinetic display.

7. A method of driving a display, the method comprising:
applying a switching voltage to the display, the switching voltage causing an amount of electrically charged pigment particles to be compacted into a number of wells defined in a dielectric layer in the display;
applying a transition waveform to the display;
applying a holding voltage to the display.

8. The method of claim 7, in which the transition waveform is applied according to an inverse exponential function.

9. The method of claim 8, in which the inverse exponential function is:
$$\frac{a}{{e}^{bx}}$$
in which “a” is the voltage difference between the switching voltage and the holding voltage, “x” is dependent on the sample rate of the display, and “b” is a step value of the sample rate.

10. The method of claim 9, in which “a” and “b” are dependent on the type of electrically charged pigment particles, display architecture, fluid used in the display, or combinations thereof.

11. The method claim 7, in which the display is an electrokinetic display.

12. The method of claim 7, in which the transition waveform is applied according to a cosine function, a linear ramp, an arbitrary waveform, a custom made curve, or combinations thereof.

13. A computer program product for driving a display, the computer program product comprising:
a computer readable storage medium comprising computer usable program code embodied therewith, the computer usable program code comprising:
computer usable program code to, when executed by a processor, apply a switching voltage to the display, the switching voltage causing an amount of electrically charged pigment particles to be compacted into a number of wells defined in a dielectric layer in the display;
computer usable program code to, when executed by a processor, apply a transition waveform to the display;
computer usable program code to, when executed by a processor, apply a holding voltage to the display.

14. The computer program product of claim 13, in which the transition waveform is applied according to an inverse exponential function.

15. The computer program product of claim 14, in which the inverse exponential function is:
$$\frac{a}{{e}^{bx}}$$
in which “a” is the voltage difference between the switching voltage and the holding voltage, “x” is dependent on the sample rate of the display, and “b” is a step value of the sample rate.
